(19) United States
(12) Patent Application Publication
(10) Pub. No.: US 2011/0112660 A1
(43) Pub. Date: May 12, 2011

(54) FIRE PROTECTION DEVICE, METHOD FOR PROTECTING AGAINST FIRE, AND COMPUTER PROGRAM

(76) Inventors: Ralph Bergmann, Neubeuern (DE); Bernd Siber, Baiern-Antholing (DE); Ewald Poitner, Feldkirchen (DE)

(21) Appl. No.: 13/000,245

(22) PCT Filed: Jul. 29, 2009
(86) PCT No.: PCT/EP09/59786

§ 371 Date: Dec. 20, 2010

(51) Int. Cl. G05B 13/04; G06G 7/48

(52) U.S. Cl. 700/29; 703/6

(57) ABSTRACT

The invention relates to a fire protection device (1) having an input module (3) designed to receive fire data in a protection area, an evaluation module (2) designed to process fire data and to generate a processing result, and an output module (4) designed to activate and/or control protection actions (12, 13, 14, 15) based on the processing result of the evaluation module (2), wherein the evaluation module (2) comprises a prediction unit (5) designed regarding the program technology and/or control technology to predict a fire course based on the fire data as a processing result.

### BACKGROUND INFORMATION

The invention relates to a fire safety device comprising an input module designed to receive fire data in a safety area, an evaluation module designed to process fire data and generate a processing result, and an output module designed to activate and/or control safety actions on the basis of the processing result of the evaluation module. The invention furthermore relates to a method for protecting against fire, and a computer program.

Fire alarm systems are typically installed in public buildings, production facilities, train stations, etc., and are used to detect and report fires and to output countermeasures such as acoustic warnings, optical warnings, escape route directions, etc. Furthermore, fire alarm systems of that type are typically designed to forward the fire alarm to the appropriate rescue personnel or the fire department.

In the case of fire alarm systems for large projects comprising several thousand fire alarms, it is also typical to depict fire alarms visually in a 2D building plan. In this manner, the administrator, building superintendent, or rescue personnel can see the position of the fire source, can orient themselves quickly, and can instruct additional rescue personnel who may be arriving.

Fire flaps or doors are usually controlled statically i.e. a fire alarm is triggered and a fire flap coupled thereto opens automatically e.g. to keep a rescue route free of smoke. The escape routes are labelled with simple escape route signs to provide guidance to the escaping persons.

A more complex fire alarm system is disclosed, however, in DE1020050121736A1 which is the closest prior art. Described in that laid-open application is a device for controlling rescue actions, in the case of which sensors are located in an area that is accessible to persons. The sensors are connected to a computer which determines what rescue actions to take based on the location of the persons, the characteristics of the area, and the location of at least one source of danger. Possible rescue actions include evacuating persons, providing guidance to rescue personnel, or technical measures such as closing and opening fire-safety doors.

### DISCLOSURE OF THE INVENTION

Within the scope of the invention, a fire safety device having the features of claim 1, a method having the features of claim 11, and a computer program having the features of claim 12 are disclosed. Preferred or advantageous embodiments of the invention result from the dependent claims, the description that follows, and the attached figures.

A fire safety device within the scope of the invention is presented, which is preferably suitable for and/or designed to protect a complex safety area which preferably has a plurality of individual regions separated by doors or passages, such as a multistoried house. The fire safety device can be designed as a central unit and can be implemented e.g. in a computer and/or a server. As an alternative thereto, the fire safety device is distributed decentrally, it being possible for individual modules of the fire safety device to communicate with one another in a wired or wireless manner, and/or via a network, in particular the Internet.

The fire safety device comprises an input module which is programmed and/or electronically configured to receive fire data from the safety area. The fire data are preferably designed to represent a current state of a fire or a fire source and/or secondary emissions of the source of the fire, such as the development of toxic fumes or temperature.

The fire safety device comprises an evaluation module which is designed to process fire data and generate a processing result. The evaluation module is therefore programmed and/or electronically configured to interpret fire data.

Furthermore, the fire safety device comprises an output module which is electronically configured and/or programmed to activate and/or control safety actions on the basis of the processing result of the evaluation module.

In the simplest configuration, the fire safety device according to the invention therefore comprises the input module for the input of data, the evaluation module for processing data and generating the processing result, and the output module for the output of data. Optionally, the modules are connected and/or can be connected to peripheral devices such as fire alarms, sensors, actuators, signal transducers, and/or warning devices, etc.

In delineation from the known prior art, it is provided that the evaluation module comprises a prediction unit which is programmed and/or designed in terms of control technology to predict a fire course as the processing result on the basis of fire data. The prediction unit is therefore designed to determine a future fire status.

One consideration of the invention is to utilize the prediction of the future fire course to increase the safety of endangered persons since safety measures can be implemented proactively. In the same manner, the deployment of rescue personnel can be better coordinated since the current fire status as well as the future fire status can be evaluated.

According to one possible embodiment, the invention makes it possible to simulate e.g. scenarios of the fire spreading, in which case the prediction unit is preferably supplied permanently with input data, in particular fire data, thereby making it possible to predict the fire course or the future status of the fire with adequate certainty. According to one possible implementation, a previous fire course, i.e. from the instant the fire was detected up to the present time t0, is therefore appended with a prediction of how the fire will develop, that is, from the present time t0 into the future.

Possible embodiments utilize e.g. three-dimensional simulations of air flows to predict how smoke and fire will spread, three-dimensional temperature distribution models, and/or analytical functions and their extrapolation e.g. to estimate the quantity of smoke that is produced. The prediction can also be carried out e.g. using a linear model, a non-linear model, an adaptive model, fuzzy logic, neural networks, or in another manner. In particular, the processing result is calculated, estimated, and/or determined in real time during the run time of the fire safety device.

The advantage of the invention is that the continual analysis of the current development of the fire, and the future prediction make it possible to implement safety actions in an updated and optimized manner that is tailored to the particular situation. The advantage becomes apparent in particular when compared to conventional fire alarm systems, in which e.g. simulations of how smoke from virtual fires will spread are investigated when making plans or projections, and the activation of ventilation flaps to supply fresh air or withdraw smoke can be specified in a consistent manner depending on the location of the fire. Due to the large number of sites at which the fire may have originated and the ways in which the fire may spread, it is not possible to account for all fire scenarios in the determination of control rules for the ventilation flaps and the like, and therefore the countermeasures to implement during an actual fire can only be implemented statically and therefore suboptimally. In contrast, the invention makes it possible to perform a continuous, current real-time analysis and real-time evaluation of the current and future fire situation.

According to a particularly preferred embodiment of the invention, the prediction unit is designed to predict the course of the fire on the basis of a model of the safety area. The model is preferably designed such that it includes complex building data, thereby making it possible to predict the fire course with good probability in conjunction with the fire data. The model includes one or a few of the following examples of complex building data, or any combination thereof:

A basic outline or plan of the safety area provided in a two-dimensional and/or three-dimensional depiction. Optionally, a three-dimensional model of the safety area is also generated by computer on the basis of a two-dimensional ground plan.

Another good source of information is a list of materials, in particular the materials used in the safety area, in particular for floor coverings or furnishings such as curtains, wooden floors, rugs, etc. If the furnishings are changed, e.g. rugs are replaced with tiles, then the risk of danger also changes since tiles do not burn. Structural changes of that type that are used to update the model can also be accounted for in the prediction of the fire course.

Additional components of the model can be data on fire loads, in particular partitions, office furnishings such as furniture, etc.

If the safety area includes a warehouse, it is preferable for the model to include the inventory, in particular the type of material in inventory, the quantity and/or hazard class thereof, etc.

Particularly preferably, every type of material that is present, every fire load, and/or every inventory is cataloged according to fire classification and/or fire property in order to improve the prediction. In addition, the model can include additional information on the safety area, in particular opened and/or closed states of doors, gates, windows, etc., e.g. to improve the prediction of air flows.

In terms of operating the safety device, it is preferable for every change to the model to be implemented by personnel or in an automated manner, to ensure that the prediction is always reliable.

According to a preferred development of the invention, the input module is connected and/or connectable to one or a few of the following input devices—or any combination thereof—to receive fire data and/or other data that can be used as a basis for predicting the course of the fire:

Fire data sensors, e.g. fire sensors, temperature sensors, smoke density sensors, or carbon dioxide or carbon monoxide sensors to directly collect fire data. However, it is also possible to use measured values from sensors in the heating and/or air conditioning system, e.g. to determine temperatures or carbon dioxide concentrations, as the input devices for the fire safety device. Further options include the use of surveillance cameras that can detect smoke or fire emissions e.g. in hallways.

Another possible type of input device for the fire safety device is the use of surveillance cameras, break-in sensors, access sensors, and other sensors that provide information about persons who are still in the building, and where they are. In particular, such sensors can also determine the distribution of the persons and e.g. detect a panicked rush toward escape doors, etc.

According to a possible development of the invention, the fire safety device is formed by other systems, such as fire detection centers, access systems, break-in detection centers, and/or video surveillance systems to receive fire data and/or other data which can be used as the basis for predicting the course of the fire or to improve the selection of safety actions. By integrating the fire safety device, these systems which may already be present can be connected to the fire safety device, thereby reducing the amount of installation work and investments required.

One possible safety action that is triggered by the output module is an optimization of escape routes. The optimization of escape routes is implemented e.g. by using pictograms that change, loudspeaker announcements, or other types of instruction. Predicting the course of the fire makes it possible to define the escape routes in a manner such that the endangered persons can be guided out of the safety area as safely as possible. Optionally, by detecting the persons and possibly their distribution within the safety area, it is also possible to prevent jams or delays. Additional input data such as the state of doors, gates, and other obstacles can also be taken into consideration.

A further possible safety action is an optimization of the guidance along the rescue route e.g. to guide firefighters to persons to be rescued, or to sources of the fire. For example, the routes for the rescue personnel can be laid out such that they do not collide with the escape routes of persons who may be panicked.

A further possible safety action is to track the rescue personnel; this embodiment increases the safety of the rescue personnel.

A further possible safety action is a three-dimensional, in particular, visualization of the fire and the future course of the fire in the safety area, wherein the current and future spread of the fire can be depicted, for example. This depiction provides a tactical overview for the rescue personnel. The three-dimensional visualization of fire and the safety area, in particular of the building, optionally makes it possible to implement additional functions such as zooming, reducing, rotating, and changing the view and the perspective.

The visualization, in particular the three-dimensional depiction, can be supplemented with a transparent depiction, i.e. a plurality of rooms can be examined simultaneously without having to laboriously scan all perspectives in a single depiction. It is also possible to design a virtual guidance of a camera in an automated manner so that critical areas can be approached and scanned automatically using the “virtual” camera from several perspectives in a repeating cycle. As an option, the depiction or visualization can be supplemented with live images from a surveillance camera at the particular locations in the visualization.

A further subject matter of the invention relates to a method for protecting against fire, having the features of claim 11, wherein current fire data on a current fire status are continuously entered, a fire course is predicted or forecast on the basis of the current fire data, and safety actions are controlled or activated on the basis of the predicted fire course. Preferably, the method is implemented on a fire safety device according to one of the preceding claims. The method once more underscores that the future fire course is calculated currently and/or in real time.

A final subject matter of the present invention relates to a computer program having the features of claim 12.

### BRIEF DESCRIPTION OF THE DRAWINGS

Further features, advantages, and effects of the invention result from the following description of a preferred embodiment of the invention. In the drawings:

FIG. 1 shows a block diagram which illustrates the device according to the invention and the method according to the invention.

### EMBODIMENT(S) OF THE INVENTION

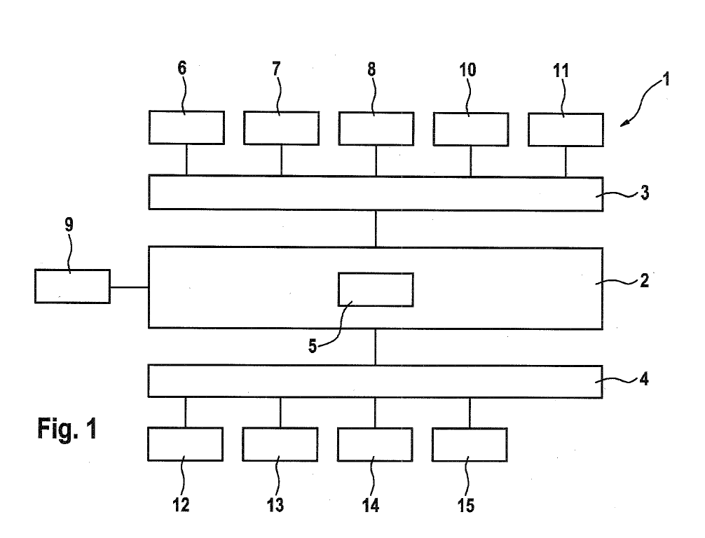

FIG. 1 shows a schematic block diagram of a fire safety device 1 having components, some of which are optional, as an embodiment of the invention. Fire safety device 1 is implemented e.g. in spacious building complexes such as universities, manufacturing plants, company grounds, airports, train stations, schools, etc., and are used to improve the passive safety of these safety areas.

Fire safety device 1 makes it possible to control and/or activate, in particular to select, safety actions in the case of fire on the basis of an evaluation of a current and/or previous fire course, and a future predicted and/or extrapolated fire course or fire status, which is also referred to collectively as the future fire course or fire status. Fire safety device 1 thereby implements dynamic-intelligent fire management.

The main components of fire safety device 1 are an evaluation module 2, an input module 3, and an output module 4. To determine the future course of the fire, evaluation module 2 includes a prediction unit 5 which estimates the future fire status on the basis of various input data. The estimation, which is also referred to as the prediction, is performed e.g. using a simulation, in particular a three-dimensional simulation of the safety area and/or analytical calculations, thereby making it possible to predict the future course of the fire with sufficient probability. Grid models or finite element methods can also be used for the prediction.

Input module 3 is connected to a plurality of systems and/or input devices for transferring input data which can be used to estimate the future course of the fire. Although FIG. 1 contains a very large number of such systems and input devices, a portion of the systems or input devices should be considered to be optional and can even be omitted in smaller embodiments of fire safety device 1. On the other hand, it is also possible to use a larger number of systems or input devices.

To accept fire data as input data which contain immediate information about a fire, input module 3 is connected to a plurality of sensors 6 which are designed to directly register the fire data. Such sensors 6 include e.g. temperature sensors, smoke or smoke density detectors, CO— or CO2 sensors, automated fire alarms, surveillance cameras that can detect a fire via the optical emissions and/or smoke that forms, etc.

As an option, such sensors 6 are also part of a fire alarm system 7 which comprises, in addition to the above-noted sensors, activatable manual fire alarms and further state sensors and/or alarms, the output signals and data of which can be used as fire data for input module 3. In an analogous manner, input module 3 can also be coupled to a video surveillance system 8 which delivers, as the input data, image data and/or fire data on fire emission or smoke development.

The input data from sensors 6, fire alarm system 7, and/or video surveillance system 8 are provided by input module 3 to prediction unit 5.

Further input data for prediction unit 5 are provided in the form of a model 9 of the safety area, which comprises complex building data on the safety area. These detailed building data of the safety area contain e.g. ground plans, maps of the safety area in a 2D or 3D depiction; fire sections; materials that are present, such as rugs, wooden floors, curtains, etc.; fire loads such as partitions, office furnishings; inventories such as the type of material in inventory, the quantity and hazard classification thereof, etc.; general building information such as door, gate, window open or closed.

On the basis of the fire data and the further input data, and model 9, prediction unit 5 can estimate—proceeding from a previous and/or current fire status at a time t0—a future fire status for a time t1, wherein t1>t0. The importance of model 9 for the estimation is illustrated in the following using two non-limiting examples:

### EXAMPLE 1

A tire warehouse fulfills an order for a large customer. As a result, the inventory changes from 10,000 automobile tires to 7,500, that is, 2,500 tires leave the warehouse.

Once the delivery has been completed, the inventory capacities necessarily change. The hazardous material “tire”, which is assigned to a defined fire classification, would now behave differently if a fire would break out since the capacities were reduced, that is, fewer tires could burn. This information is incorporated as a change in the model for that used by prediction unit 5. This improves a reliable simulation, wherein the modified input data also change the output data i.e. the prediction.

### EXAMPLE 2

If the furnishings in an office are changed, e.g. rugs are replaced with tiles, then the risk of danger also changes in this case since tiles do not burn. This change is also accounted for in the prediction by model 9.

Preferably, the particular fire classification of most or all of the objects in the safety area, regardless of whether they are mobile or permanently installed, is known as further input data to be incorporated as input into the prediction.

Using the available fire data and input data as the prediction input, a prediction/simulation of the fire is calculated using algorithms. If the prediction input changes, this directly affects the prediction output and the simulation of how the fire will spread.

As an optional further addition, input module 3 can be connected to a break-in detection center 10 to exchange data, wherein data on the state of doors, gates, windows, and other changeable building properties are transmitted. These building properties influence the further course of the fire and thus represent valuable prediction input for prediction unit 5, which can be accounted for in the simulation or prediction.

Furthermore, input module 3 can be connected to an access system, wherein the number of persons present in the safety area is determined e.g. to enable escape routes to be planned in advance. In addition, access system 11 and/or video surveillance system 8 can be used to determine the distribution of persons within the safety area, and so gatherings of persons, jams, etc. that occur when fire breaks out can be accounted for in the planning of escape routes.

On the basis of the processing result of prediction unit 5, i.e. the future fire course, output module 4 selects, activates, and/or controls safety actions.

A first safety action is implemented by a visualization module 12 for the three-dimensional visualization of the fire in the safety area and the future fire course. In this case, the current and future spread of the fire can be depicted e.g. to provide a tactical overview for the rescue personnel. The three-dimensional view of the fire and the safety area, in particular of a building, also makes various additional functions possible, such as zooming, reducing, rotating, changing the view and perspective, etc. As an option, a transparent depiction can be added to the three-dimensional visualization, that is, it is possible to examine a plurality of rooms simultaneously without having to laboriously scan all perspectives. There is an option to design the “camera guidance” to be automated so that critical areas can be approached/scanned automatically using the “virtual” camera from several perspectives in a repeating cycle. The depiction can be supplemented with “live” images from a video camera at the particular location having a graphical image.

As a further optional function, certain rooms can be characterized manually by rescue personnel, administrators, etc. as being blocked, in which case the blockage can be viewed as on-line information by any user.

An escape route module 13 is used to evacuate persons in a dynamically optimized manner. On the basis of the current and future-oriented simulation of the fire, rescue routes can change and/or must be adapted to the particular circumstances. If emergency exits become impassable due an excessively large number of persons trying to access them, the persons can be redirected to the next closest emergency exit. An escape route, which is indicated by a controllable escape route pictogram and becomes unsuitable as an escape route (e.g. due to fire or smoke spreading there) is modified in such a manner that it no longer leads the persons into the simulated fire.

The route directions are displayed dynamically and not statically, and can be changed at any time.

A module of routes for rescue personnel 14 is used to guide deployed personnel in a dynamically optimized manner, not only for endangered persons, but especially for rescue personnel. If e.g. endangered persons are detected via video camera/motion alarm, the module of routes for rescue personnel 14 can show the rescue personnel the optimal smoke- and fire-free route to the defined sections/rooms. Firefighters can be provided with information about the location at which the fire originated. The instructions or proposed routes can be depicted in a wired or wireless manner using suitable technology such as Ethernet, UMTS, WLAN, etc., at a central rescue control center at the fire department or e.g. on portable tablet PCs used by the firefighters.

Furthermore, it is also possible to dynamically track rescue personnel using a localization system 15, to minimize the risk to rescue personnel.

Depending on the embodiment, useful advantages of the invention are therefore the prediction of fire and how it will spread or the course thereof in a three-dimensional depiction of the fire and simulation on the basis of permanently delivered input data; a dynamically optimized evacuation of persons (e.g. using changing pictograms); dynamically optimized guidance of firefighters to the persons to be rescued/to the sources of the fire; a dynamic, continuously changeable, variable control of ventilation flaps, doors, control cabinets, etc. depending on the fire simulation as the output of the prediction. On the basis of this prediction, all subsequent activities (=output) are controlled in a dynamic-intelligent manner, even including building management activities, for instance (elevators/control cabinets/fire flaps/pictograms, etc.).

What is claimed is:

1. A fire safety device (1) comprising an input module (3) designed to receive fire data in a safety area, an evaluation module (2) designed to process fire data and generate a processing result, and an output module (4) designed to activate and/or control safety actions (12, 13, 14, 15) on the basis of the processing result of the evaluation module (2),
characterized in that
the evaluation module (2) comprises a prediction unit (5) which is programmed and/or designed in terms of control technology to predict a fire course on the basis of the fire data as a processing result.

2. The fire safety device (1) according to claim 1,
characterized in that
the prediction unit (5) is designed to predict a fire course on the basis of a model (9) of the safety area.

3. The fire safety device (1) according to claim 2,
characterized in that
the model (9) of the safety area comprises one or a few of the following bits of complex building information, or any combination thereof:
A basic outline or plan of the safety area in a two-dimensional and/or three-dimensional depiction;
Materials used in the safety area, in particular for floor coverings, furnishings (e.g. curtains), etc.;
Fire loads, in particular partitions, office furnishings, etc.
Inventories, in particular the type of material in inventory, the quantity and hazard class thereof, etc.
State information on the building, in particular the opening state of doors, gates, windows, etc.

4. The fire safety device (1) according to claim 1,
characterized in that
the input module (3) is connected and/or connectable to one or a few of the following input devices (9)—or any combination thereof—to receive fire data and/or other input data that form or can form a basis for predicting the course of the fire:
Fire sensor
Temperature sensor
Carbon dioxide/carbon monoxide sensor
Surveillance camera
Break-in sensor
Access sensor

5. The fire safety device (1) according to claim 1,
characterized in that
the input module (3) is connected and/or connectable to one or a few of the following systems—or any combination thereof—to receive fire data and/or other data that form or can form e.g. a basis for predicting the course of the fire:
Fire detection center (7)
Access system (11)
Break-in detection center (10)
Video surveillance system (8).

6. The fire safety device (1) according to claim 1,
characterized in that
one possible safety action is an optimization of escape routes (13).

7. The fire safety device according to claim 1,
characterized in that
one possible safety action is an optimization of the guidance along the rescue route (14).

8. The fire safety device according to claim 1,
characterized in that
one possible safety action is tracking (15) of rescue personnel.

9. The fire safety device according to claim 1,
characterized in that
one possible safety action is a three-dimensional, in particular, visualization (12) of the fire and the future course of the fire in the safety area.

10. The fire safety device according to claim 9,
characterized in that
the visualization (12) comprises a three-dimensional depiction of the safety area, it being possible to depict the safety area in a partially transparent and/or transparent manner, thereby enabling a plurality of regions of the safety area, which are separated by ceilings and overlap in the viewing direction, to be monitored simultaneously.

11. A method for protecting against fire, wherein current fire data on a current fire status in a safety area are continuously entered, a fire course is predicted or forecast on the basis of the current fire data, and safety actions are controlled or activated on the basis of the predicted fire course.

12. A computer program comprising program code means for carrying out all steps of the method according to claim 11 when the program is run on a computer and/or a fire safety device (1).
